(19) United States
(12) Patent Application Publication
(10) Pub. No.: US 2008/0169159 A1
(43) Pub. Date: Jul. 17, 2008

(54) Method of Transporting Persons In a Building

(76) Inventors: Lukas Finschi, Lucerne (CH); Paul Friedli, Remetschwil (CH)

Correspondence Address: Klaus P. Stoffel;Wolff & Samson, One Boland Drive, West Orange, NJ, 07052, US

(21) Appl. No.: 11/792,213

(22) PCT Filed: Nov. 28, 2005
(86) PCT No.: PCT/CH2005/000706

§ 371 Date: Jun. 21, 2007

(30) Foreign Application Priority Data
Dec. 1, 2004 (EP) 04106222.5
Aug. 12, 2005 (EP) 0510746604

(51) Int. Cl. B66B 1/20

(52) U.S. Cl. 187/383

(57) ABSTRACT

The invention relates to a method and an arrangement for transporting people in a building by means of a lift installation (10) comprising at least one lift cage (11). Said lift cage (11) is entered by people on at least one first access floor (S1, S2). In order to increase the transport efficiency, at least one target floor (S3, S4, 55, S6, S7) is associated with the access floor (S1, S2) in a fixed manner, in such a way that the lift cage (11) travels from the first access floor (S1, S2) to the target floor (S4, S5, 56, S7) associated therewith.

The invention relates to a method of transporting persons in a building by means of a lift installation, which comprises at least one lift cage, wherein the lift cage is entered by persons at at least one first access storey. The invention further relates to an arrangement for transporting persons in a building with a lift installation, which comprises at least one lift cage, wherein at least one access storey is provided.

Lift installations are used for transportation of persons in publicly used buildings. The passengers in railway stations, airports and shopping centres are usually accompanied by bulky luggage or shopping trolleys. Due to the high loading of lift installations complicated lift control programs are used in order to increase the effectiveness in the transportation of persons. For example, a destination call control is used by way of which a passenger inputs his or her travel destination by means of an input device. A lift control then allocates a lift cage to the corresponding person on the basis of the desired destination storey. It is thus achieved that persons having common destination storeys are concentrated in a lift cage, so that the travel time of the lift cage is not prolonged by numerous intermediate stops.

A control device for controlling a lift installation with a multiple cage is known from EP 1 418 147 A1. The multiple cage has several cage decks which are simultaneously accessible at a main stopping point by way of different main stopping planes. Two storeys of a building can be served at the same time by the multiple cage with one stop. A call registration device by means of which a passenger can input his or her desired destination storey is provided at the main stopping point. In order to enable a more rapid filling of the building and to minimise the number of intermediate stops of the multiple cage a computing unit is provided which is constructed for the purpose of determining on the basis of the destination call input of a passenger at the main stopping point and on the basis of already assigned and/or placed travel requests which cage deck of the multiple cage is assigned to the passenger at the main stopping point. The passenger is thus allocated, in correspondence with his or her destination call input, a plane enabling effective transportation of persons by means of the multiple cage. After input of the destination call the passenger must then go to the appropriate plane in order to enter the multiple cage at the corresponding plane.

The assignment of persons to multiple cages by means of a destination call control and even assignment of persons to single lift cages by means of destination call control requires a complex control. Notwithstanding this destination call control delays in the transportation of persons occur particularly at peak time, since, for example, persons who have not made a destination call board lift cages.

Against this background the object of the present invention results as indicating a method and an arrangement for transporting persons in buildings in which the number of intermediate stops at storeys of a building is minimised and shorter travel times are achievable.

The invention is based on the concept that at least one destination storey is fixedly allocated to an access storey, i.e. at least one lift is provided at an access storey and travels to a predetermined destination storey. This fixedly predetermined destination storey is not, as usual, established by a manual call input of a passenger, but is automatically established by the lift control. The lift control can determine the fixedly allocated destination storey for a specific period or constantly in dependence on the structure of a building and on the occupancy, in terms of time, of the different storeys. The fixedly predetermined destination storey is preferably the most likely travel destination of a passenger per building part and at a certain time. By “fixedly allocated” there is meant, in particular, that the storey is no longer changed after at least one person has entered the lift cage.

For example, the fixedly allocated storey can be, during the opening times for filling up a parking facility of a building, the floor where a shopping centre lies, since the persons in the parking facility at this time of day most probably want to go to the floor of the shopping centre.

In the case of conventional destination selection of controls passengers input their destination intentions explicitly at so-termed destination selector terminals by input of a destination floor. In addition, the destination intention can also be communicated implicitly by the presentation of an identification medium insofar as an automatic destination was filed in a data bank beforehand for the corresponding day. The present invention, thereagainst, consists in that the instantaneous destination is situationally known to the lift control. If, for example, individuals move in a shopping centre from a parking floor in direction towards lifts there is a high probability that they want to reach the shopping floor. If they move in opposite sense, possibly with a full shopping trolley, from the shopping floor in direction towards lifts then they probably want to go back to the parking floor. Depending on the respective floor and movement direction the travel destination is predictable in both these cases and can thus be automatically triggered and signalled. In addition, in the case of several possible destinations, such as, for example, several parking floors, different lifts of a group can be conducted to these destinations. On the other hand, however, also several destinations can be allocated by the lift control in advantageous predetermined manner in succession to one lift.

The invention offers, inter alia, the following advantages:

Passenger flows can be controlled efficiently in such a manner, particularly in the case of strongly frequented lift installations for passengers with luggage or shopping trolleys, that formation of a build-up by waiting or undecided passengers is largely avoided. In the case of large cages it is possible to further avoid the situation that passengers standing in the region of the door have to prematurely disembark and re-embark together with their luggage in order to make space for passengers standing further back and wanting to disembark. This is achieved in that in each instance only passengers for the same destination are located in the cage. The invention is advantageous particularly in publicly used buildings where passengers without knowledge of the location frequently visit or passengers who due to bulky luggage do not have a hand free for a selective call input.

Modern office buildings often have several access storeys. If several access storeys are present, by way of which the building is opened up, the performance capability of the lift installation can be increased if at least one destination storey is fixedly allocated to the destination storeys. In the case of the refinement in accordance with the invention the lift cage travels from a first access storey to at least one fixedly allocated destination storey. According to the invention persons can thereby be so guided to the lift that they are transported from an access storey to the allocated destination storey without an intermediate stop. Through the assignment of persons to the respective correct lift, persons with the same destination storey enter the same lift cage. From there the lift cage travels directly to the appropriate destination storey.

By contrast to the assignment, which is known from the state of the art, of lift cages by means of destination call control there is carried out here an assignment of persons to lift cages with fixed destination storeys.

It is thus ensured that, for example, the customers of a shopping centre travelling to the same destination storey always enter the same lift cage at the access storey and travel from there to their destination storey. Customers of another company accommodated in another storey use, for example, a different lift cage which travels to the destination storey at which the other company has its offices. Transportation in the lift cages takes place without intermediate stops at the storeys.

In a simple embodiment the invention can be constructed with a lift cage which travels from a first access storey to a fixedly allocated destination storey at, in particular, appropriate times. Thus, persons with the same destination storeys can be guided to the same lift cages, whereby travel times of the lift cages are substantially reduced.

An efficient conveying of persons can thereby be made possible particularly at rush hours. Flows of persons can be guided by the method according to the invention, wherein also several lifts are effectively utilised. There is avoidance of the situation that all persons who would like to be transported in this building wait at an access storey for a single lift cage and have to be assigned to the lift cages in dependence on the destination call inputs. In addition, there is avoidance of the situation that customers not only of a shopping centre, but also of a second company board the same lift cages at the access storey and travel from there to their destination storeys. In this case the lift cage would have to stop not only at the access storey, but also at first and second destination storeys. Particularly when two lift cages are provided for transportation, it is more effective to allow one lift cage to travel from the access storey directly to the first destination storey and the second lift cage to travel from the access storey to the second destination storey. The sole precondition for effective transportation is in this connection that the persons board the correct lift cages at the access storeys.

Advantageous embodiments of the invention can be inferred from the subclaims.

In a special embodiment of the invention it is possible that a first group of destination storeys for a lift cage is fixedly allocated to an access storey. A reduction in the possible intermediate stops is thus achieved, whereby the travel time is minimised.

Indicating devices can be used to illustrate the fixed allocation of destination storeys to the respective lifts. Persons who would like a first facility can read off the respective lift and move towards it without the destination storey having to be actively input by the passenger. This is advantageous particularly when the allocation of the destination storeys to the lifts is variable, so that the users have to reorientate with regard to which lift cage travels to their destination storey. In the case of non-variable allocation of destination storeys to the lifts the assignment or guidance of persons to the lifts can be carried out by a permanent inscription in the building.

The flows of persons can be efficiently coordinated by the method according to the invention so that, for example, persons who want to go to the uppermost floor in the shopping centre are recognised by an access terminal on entry into the building and then assigned to a lift from which a lift cage travels directly to the storey in which the shopping centre is located. Other destination storeys cannot be reached by visitors of the shopping centre without manual destination input.

The access terminal preferably has sensors such as, for example, optical, acoustic, infrared, radar, movement or video sensors, which can recognise persons approaching the lifts.

Features of the passengers, such as being accompanied by shopping trolleys or sports bags, are preferably recognised by the sensor so as to be able to propose an appropriate destination storey.

The method according to the invention can be used particularly efficiently if the lift installation has several lift cages, wherein a first lift cage serves a first destination storey and the second lift cage serves a second destination storey. If beyond that still further lift cages are arranged in the lift installation for the transportation of persons it is possible that several lift cages travel from an access storey fixedly to a destination storey or that an additional lift cage for the transportation of persons to other destination storeys, for which no fixed allocation is present, is provided.

In a preferred refinement of the invention the destination storeys are fixedly allocated to the access storeys only at specific times. The fixed allocation of destination storeys to the lifts offers itself particularly at peak times in order to efficiently cover the increased need for transport. Between the peak times, all destination storeys in the building can be reached by the lift cages.

Specific destination storeys may advantageously be allocated only when the facilities located there, such as businesses, restaurants, leisure facilities, means-of-transport, etc., are open or ready for operation.

The fixed allocation of destination storeys to access storeys is in certain circumstances undertaken in time-dependent manner.

In the case of an arrangement in accordance with the invention for transport of persons in a building with a lift installation the lift installation comprises at least one lift cage, wherein at least one access storey is provided and at least one destination storey is fixedly allocated to the access storey.

In an advantageous embodiment it is provided that a building control unit undertakes the assignment or guidance of persons to lifts in accordance with the destination storeys thereof, wherein the building control unit is advantageously coupled with access terminals. The access terminals can be constructed as a part of the building control unit. The access terminals recognise a passenger. A lift call is actuated from this recognition directly in the access terminal or in the building control unit and a lift cage is indicated to the person.

Moreover, an indicating device for indication of allocation of the destination storeys to the access storeys is preferably provided. The indicating device can be constructed in the form of a display in order to indicate a variable allocation of lifts to destination storeys. The indicating device can, however, also be constructed as a simple information panel in the case of a fixed allocation.

In the lift cage itself advantageously the next destination or destinations is or are indicated and announced so that the passengers also receive confirmation of the destination storey without active destination input.

Beyond that the system is advantageously learning-capable and automatically offers, by virtue of the use habits of passengers at specific times of day, the respectively sought destination storeys.

Moreover, input terminals advantageously also allow selective input of a destination storey if this should not be offered at the desired point in time. It is possible to use the fixed allocation of destination storeys to the lifts in combination with a destination call control.

The invention is explained in the following in more detail on the basis of examples of embodiment which are illustrated in schematic manner in the drawings, in which:

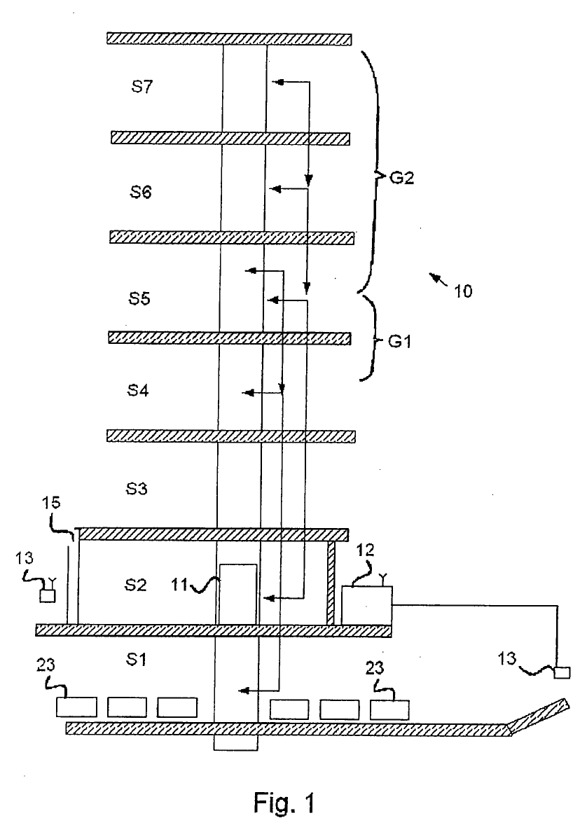

FIG. 1 shows a schematic illustration of a lift installation according to the present invention;

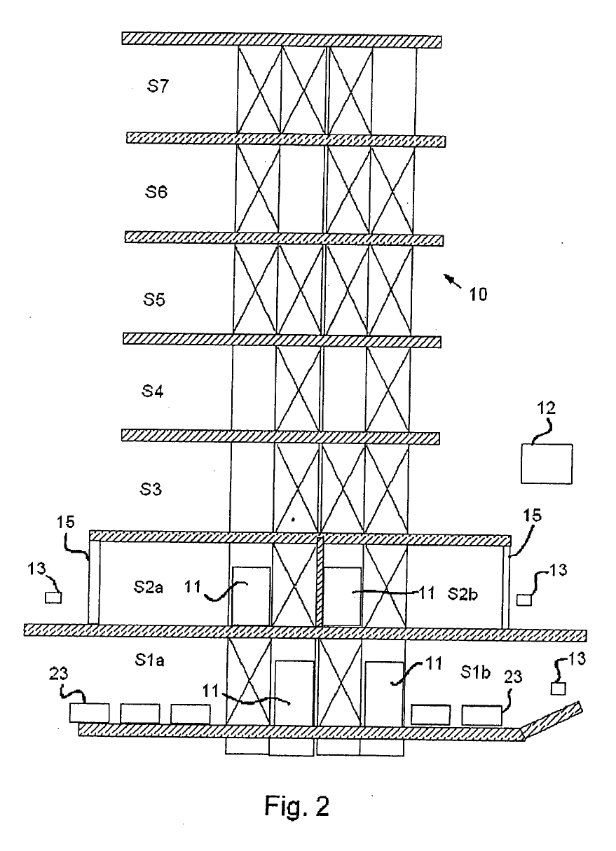

FIG. 2 shows a schematic illustration of an alternative lift control according to the present invention;

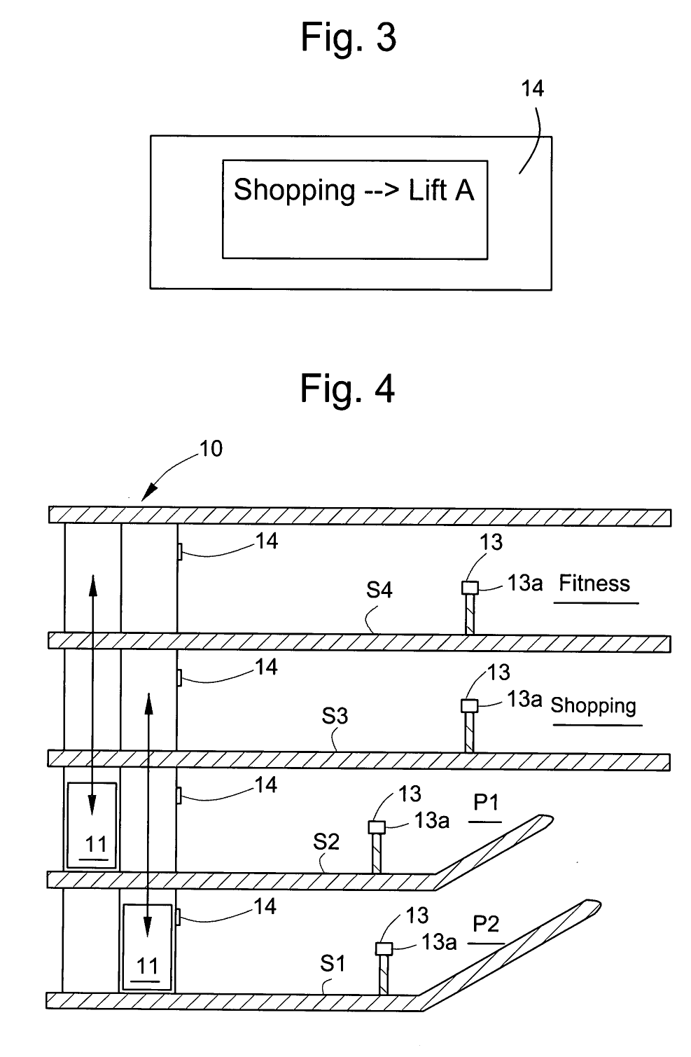

FIG. 3 shows a schematic illustration for guidance of persons and an indication of destination storeys, according to the present invention;

FIG. 4 shows a schematic illustration of a lift installation and the guidance of persons, according to one form of embodiment of the present invention; and

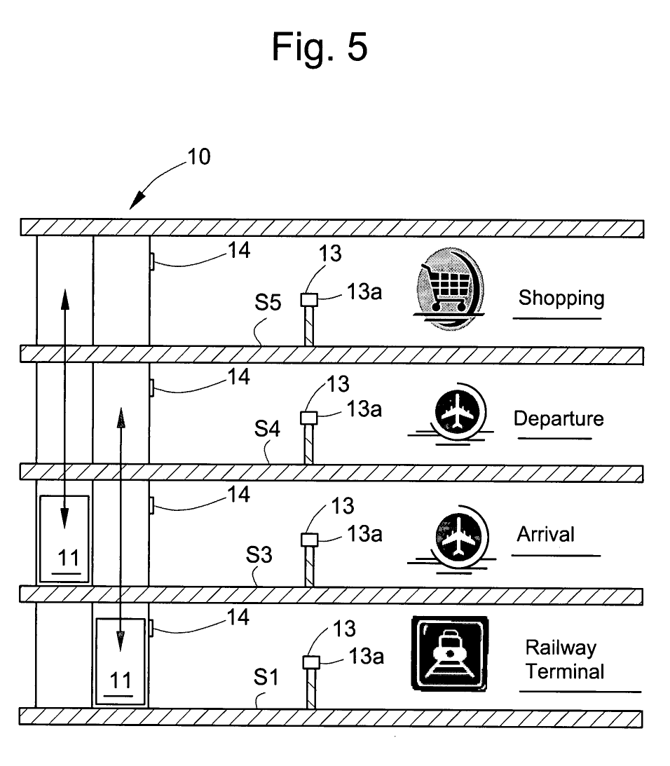

FIG. 5 shows a schematic illustration of a lift installation and the guidance of persons, in accordance with a second form of embodiment of the present invention.

A schematic illustration of a building with a lift installation 10 and with seven storeys is shown in FIG. 1. Of those, the storeys S1 and S2 are constructed as access storeys and storeys S4 to S7 as destination storeys. A lift cage 11 is moved in the lift installation 10 in order to transport persons from the respective access storeys S1 and S2 to a destination storey S4, S5, S6 or S7. The access storey S1 is an underground garage to which vehicles 23 of the persons go and where the persons are recognised by an access terminal 13. Persons who board the lift cage 11 in the underground garage or the access storey S1 are transported either to the destination storey S4 or to the destination storey S5. Persons who enter the lift cage 11 at the access storey S2 are transported to the destination storey S5, S6 or S7. The two access terminals 13 are coupled with a building control unit 12 either wirelessly via the indicated aerials or by way of a connecting line. A first group G1 of destination storeys, which comprises the destination storeys S4 and S5, can be reached from the first access storey S1. A group G2 with the destination storeys S5, S6 and S7 is allocated to the second access storey S2. The destination storeys S4 and S5 are fixedly allocated to the access storey S1. The destination storeys S5, S6 and S7 are fixedly allocated to the access storey S2.

An alternative embodiment of a lift installation 10 for use of the method according to the invention is illustrated in FIG. 2. The lift installation 10 according to FIG. 2 has four lift cages 11 which are arranged for transportation of persons. The lift installation 10 comprises four separate access storeys S1a, S1b, S2a and S2b. Persons who enter the lift cage 11 at the access storey S1a are transported to the destination storey S6. Persons who enter the lift cage 11 at the access storey S1b are transported to the destination storey S7. Persons who enter the lift cage 11 at the second access storey S2a are transported to the destination storeys S3 and S4. Thereagainst, persons who enter the lift cage 11 on the other side of the second access storey S2b are transported only to the destination storey S4. The respective access storeys S1a, S1b, S2a and S2b are opened by way of doors or barriers 15 in each instance after recognition at an access terminal 13. Destination storeys S4, S5, S6 and S7, which cannot be travelled to by individual cages 11, are provided with a large cross. There are also destination storeys S4 which are accessible by way of other lift installations (not illustrated) or only by way of stairs. Destination storeys S5 of that kind are, for example, reachable only by a manual lift cage control, for example in the case of use as a store or a safety area without appreciable traffic of persons.

The co-ordination, which is required for effective utilisation of the lift installation 10 according to FIGS. 1 and 2, of the flows of visitors or persons in a building is illustrated in FIGS. 3 and 4.

On entering a building a passenger is initially recognised by an access terminal 13. The allocation of the destination storeys is indicated on an indicating device 14. The users of the facility A (shopping centre) are automatically guided to the first lift A. Users of the facility B (fitness) have to actuate a lift call. By way of the automatic guidance to the lift A the lift cage A is automatically assigned to the shopping centre users, by which they go to the fixedly allocated destination storey S3. If in the meantime a passenger should be recognised as a customer of the fitness centre, then another or second indication appears, for example, with the reference ‘Fitness→Lift B’.

It is possible through the refinement according to the invention that the lift cage 11 in each instance has to serve only a small number of different travel destinations, whereby a higher performance capability and a higher travel convenience of the lift installation 10 are achieved.

The idea according to the invention can also be transferred in analogous manner to other applications. In the case of restaurants which extend over several storeys the respective restaurant visitors are already assigned, on driving into the parking garage, parking spaces for their vehicles 23 and lifts which correspond with their desired destination restaurant. It is further possible to reach theatres or cinemas in each instance by way of an access storey in which the parking places correspond with the respectively allocated destination storey from which the lift cage automatically travels to a theatre or to a desired cinema. The corresponding lift from which a lift cage 11 travels directly to the fixedly allocated storey with the cinema is indicated to the cinema visitor on an indicating device 14.

It is possible through the refinement of the method according to the invention and the arrangement for transporting persons to make possible rapid travel to a specific travel destination, wherein only a short waiting time and a short overall travel time to the destination are necessary.

FIG. 4 shows a schematic illustration of a lift installation and the guidance of persons in accordance with a preferred form of embodiment of the present invention.

Movement detectors 13a detect the passengers already in the frontal region of the lifts in the lift lobbies and automatically call a lift cage 11. Illuminated displays 14 inform which lift travels to which floor. The passengers are transported to the desired storey S3, S4 without destination input and intermediate stop. Manual destination inputs are necessary only still in exceptional cases. This control is suitable particularly for buildings with an intensive traffic of public between a few storeys.

Movement direction sensors 13a detecting the movement direction of passengers are to be mounted on those storeys where the passenger flows are to be automatically assigned to the destinations and lifts. If the passengers move in the direction of the lifts, one or more destination calls are automatically triggered and optionally the corresponding lifts are listed on indicating boards. Radar sensors, video sensors or other sensors can be used as directional sensors, which can distinguish disembarking passengers from potentially boarding passengers.

The automatic destinations as well as the lifts assigned to the destinations are indicated on a display on the way to the lifts; for example:
Shopping→Lift B
Fitness→Lift A

LED moving text boards, TFT, plasma or CRT displays, projectors for the projection of information on a wall or on the floor, etc., are used as displays. An acoustic announcement is also conceivable. Such signposting displays make sense particularly when at the instant of directional detection of passengers the indications about the lifts cannot yet be viewed. In order to make the indication more conspicuous, the information can also be represented in flashing manner.

Display boards 14 are mounted above or near the lift doors where the destinations served by the respective lift are listed and, in particular, as long as the door is open. During the opening time these indications typically begin to flash in order to finally extinguish shortly before door closure. The same display technologies can be used for these destination displays as for the signposting displays.

In a department store three panorama lifts 10 transport, for example, passengers between four storeys: Parking -1 S2, Parking -2 S1, Shopping 0 S3 and Fitness Centre S4.

If a passenger wants to go from Parking -1 and -2 to the floor Shopping he or she is automatically transported to his or her destination. This also applies to the return route from Shopping to Parking. Movement detectors 13a in the lift lobbies Parking -1 and -2 as well as Shopping can detect the passengers and immediately call a lift cage 11. Illuminated displays 14 above the entry doors of the three panorama lifts show which lift travels to which floor. The passenger directly and automatically reaches the floor Shopping S3 from Parking -1 and -2. In order to go back to the parking garage after shopping, a lift 11 for Parking -1 and a lift for Parking -2 is automatically provided for the passenger by the movement sensor 13a. The passenger can board the appropriate lift without destination input and is automatically transported to the desired, fixedly allocated storey. A speech announcement in the cage confirms to the passenger his or her desired destination. Disposed in the lift cage itself are only still the door closing and opening buttons as well as the alarm button. Through this installation the passengers are already grouped in the lift lobbies and thus benefit from direct journeys. In the case of large cages the lift doors automatically close only after a fixed time period since entry of the first passenger has elapsed or when the cage is full. The cage thereafter travels to the destination storey. Inconvenient boarding and disembarking with shopping trolleys between the individual storeys and long waiting times are thus eliminated.

A manual destination input is only still necessary when passengers move between the two Parking storeys -1 and -2 or want to go to the floor Fitness Centre S4. A manual destination can be input at the keyboard located between the three lifts. A lift is assigned to the passenger on the display above the keyboard and then takes the passenger directly to his or her desired destination.

FIG. 5 shows a schematic illustration of a lift installation and guidance of persons in accordance with a further preferred form of embodiment of the present invention. The floor ‘Shopping’ is optional.

Movement detectors 13a detect the passengers in an airport already in the frontal region of the lifts in the lift lobbies and automatically call a lift cage. Illuminated displays 14 inform which lift travels to which floor. The passengers are transported to the desired storey without destination input and intermediate stopping. Manual destination inputs are necessary only exceptionally.

In an airport three lifts 10 transport, for example, the passengers between four storeys: Railway Terminal S1, Arrival S3, Departure S4 and Shopping S5.

If the passengers are going to Railway Terminal, a lift cage for the storey Departure and, in the case of need, a second lift cage for the storey Arrival are automatically fixedly allocated and the passenger is automatically transported to his or her destination. The floor Departure is the most likely travel destination of a passenger in this part of the building. This also applies to the return route from the storey arrival A to the Railway Terminal. The persons wanting to go from Railway Terminal to Arrival are small by comparison and can also be expected to go by way of the Departure to the destination and disembark only at the second stopping point. Movement detectors 13a in the lift lobbies Railway Terminal and Arrival can detect the passengers and immediately call a lift cage 11. Illuminated displays 14 above the entry doors of the three lifts show which lift travels to which destination. From the Railway Terminal the passenger directly reaches the floors S3 and S4 by way of the automatic lift call. In order to go back to the Railway Terminal a lift 11 is automatically provided at the storey S3 or S4 for the passenger by the movement detector 13a. The passenger can board the appropriate lift without destination input and is directly transported to the desired storey. A speech announcement in the cage confirms to the passenger his or her desired destination. In the lift cage itself there are disposed only still the door closing and/or opening buttons as well as the alarm call button. Through this installation the passengers are already grouped in the lift lobbies and thus benefit from direct journeys. Tiresome boarding and disembarking with luggage between the individual storeys and long waiting times are thus avoided.

A manual destination input is only necessary when passengers move between the two storeys S3 and S4 or want to go to the optionally present floor Shopping S5. A manual destination can be input at the keyboard located between the three lifts. A lift is allocated to the passenger on the display above the keyboard and again takes the passenger directly to his or her desired destination.

The destinations in the lift can optionally be acoustically repeated again, for example:
While door is open:
“First Stop Departure” or
“This Lift Serves Parking Level 2”
Before opening of the door:
“Disembark Here For Departure”
“Please Disembark For Parking Level 2”.

In principle it is possible for a single passenger to trigger several calls (for example, Parking 1 and Parking 2 or even three calls). Although the invention was conceived simply to manage large passenger flows in public buildings, it can be disturbing in the case of a small traffic volume that then one of the lifts executes its journey empty. In order to prevent this, execution of the journey can be inhibited by means of an empty recognition and the lift remains, after door closing, simply at a standstill. For empty recognition all present-day zero-load sensors can be used. Of particular interest at present are video volume sensors which reliably recognise an empty cage.

The method according to the invention can efficiently sort very large traffic flows according to destinations, assign transport means in optimal manner and lastingly improve transport performance in that the passengers (together with their pieces of luggage, shopping trolleys and luggage trolleys, etc.) are brought to their destinations in the most direct route. The method makes sense particularly when the destinations are clear from the situation and the number thereof is not too large (preferably at most 3).

For implementation of the invention the situations defining the automatic destinations must be clearly known. It is, however, readily possible for destinations, which are not automatically triggered, to be reachable from a specific storey; these destinations must then be input at a terminal. It is merely important that the majority of passengers desire a destination from the lift of automatic destinations. There are various kinds of automatic destinations:
Destination is fixed or destinations are fixed independently of the time of day or time of week.
Destinations are dependent on a time control; for example, the destination “Shopping” is from the Parking level during the opening time for filling up and the destination “Fitness Studio” is in the evening.
Destinations are learnt: the passengers input their destination at a terminal. If sufficiently same destinations are input, this destination is generated as an automatic destination until sufficient other destinations were input at the terminal, etc.

1-15. (canceled)

16. A method of transporting persons in a multi-storey building with an elevator installation, which comprises at least one elevator cage, comprising the steps of: providing access to the elevator cage by persons at at least one first access storey; and fixedly allocating at least one destination storey to the access storey.

17. The method according to claim 16, including indicating a travel destination in advance to the persons by way of an indicating device.

18. The method according to claim 16, wherein the allocation is variable.

19. The method according to claim 16, further including recognizing arriving persons via an access terminal.

20. The method according to claim 19, wherein the access terminal comprises sensors.

21. The method according to claim 20, wherein the sensors are radar sensors or video sensors.

22. The method according to claim 20, including recognizing features of the persons by the sensor in order to be able to propose an appropriate destination storey.

23. The method according to claim 22, wherein the features are whether the persons are accompanied by shopping carts or sports bags.

24. The method according to claim 16, including indicating to arriving persons by display and/or acoustically at least one elevator for the pre-defined destination storey without the destination storey being actively input by the person.

25. The method according to claim 16, wherein the next travel destination is optically and/or acoustically indicated within the cage.

26. The method according to claim 25, wherein the next travel destination and the destination after are indicated within the cage.

27. The method according to claim 16, including automatically closing doors of the elevator only after a fixed time period from entry of a first passenger has elapsed or if the cage is full.

28. The method according to claim 16, wherein an elevator cage in each instance serves only a small number of different travel destinations.

29. The method according to claim 16, including allocating specific destination storeys only at specific times.

30. The method according to claim 16, including allocating specific destination storeys only when facilities located there are open or ready for operation.

31. The method according to claim 16, including undertaking the fixed allocation of destination storeys to access storeys in a time-dependent manner.

32. An arrangement for transporting persons in a building, comprising an elevator installation, which has at least one elevator cage, wherein at least one access storey is provided, at least one destination storey being fixed allocated to an access storey.

33. The arrangement according to claim 32, and further comprising an indicating device provided for indication of an allocation of the destination storeys to the access storeys.
